(19) United States
(12) Patent Application Publication
(10) Pub. No.: US 2007/0078754 A1
(43) Pub. Date: Apr. 5, 2007

(54) METHOD AND SYSTEM FOR MARKETING HOMES

(76) Inventor: Arthur B. Raby, Valparaiso, IN (US)

Correspondence Address: HARTMAN & HARTMAN, P.C., 552 EAST 700 NORTH, VALPARAISO, IN, 46383, US

(21) Appl. No.: 11/536,839

(22) Filed: Sep. 29, 2006

Related U.S. Application Data
(60) Provisional application No. 60/596,512, filed on Sep. 29, 2005.

(51) Int. Cl. G06Q 40/00

(52) U.S. Cl. 705/37

(57) ABSTRACT

A method and system accessible with the Internet by which a database of homebuyers and their purchase criteria is established by real estate agents of the homebuyers, and is searchable by homeowners who are considering selling their homes. Desired home criteria of a plurality of potential homebuyers are entered and stored on the system through the Internet. Home information remotely entered by a potential homeseller through the Internet is then received on the system. The system is then searched to identify one or more matches between the home information of the potential homeseller with the desired home criteria of at least one of the plurality of potential homebuyers. In response to a match being identified between the home information of the homeseller and the desired home criteria of a homebuyer, the system sends the contact information of the potential homeseller to a real estate agent.

### CROSS REFERENCE TO RELATED APPLICATIONS

This application claims the benefit of U.S. Provisional Application No. 60/596,512, filed Sep. 29, 2005, the contents of which are incorporated herein by reference.

### BACKGROUND OF THE INVENTION

The present invention generally relates to real estate transactions. More particularly, this invention relates to a method and system established with the Internet by which a database of homebuyers and their purchase criteria (e.g., price, location, amenities, etc.) is established and made accessible to homeowners who are or might consider selling their homes. When the home owner comes to the site and enters information relating to their home (e.g., price, location, home features, etc.), this information is matched to the homebuyers' purchase criteria in the database.

The Multiple Listing Service (MLS) did not exist in the United States real estate industry in the 1970's. Sharing of information was frowned upon by the real estate community. Today the U.S. real estate business relies heavily on using the MLS. The routine of a real estate agent is generally the following. The agent works with both homebuyers and homeowners. For the homeowner side of the business, the agent must solicit new business, such as by asking potential home sellers, for-sale-by-owners (FSBO), and expired listings if they would like to list with him or her. On the homebuyer side of the business, agents solicit homebuyers in various ways, including open houses and via the Internet. The Internet often generates by far the most homebuyers for an agent. Currently, about 71 percent of all homebuyers go to the Internet to look for a home. This has changed the dynamics of the business, with the result that agents find themselves bogged down with homebuyers and do not have the time to solicit home owners to sell their homes. Generally, it is believed that an agent can be more successful if his or her clients are made up of at least 40% homeowner listings, with the balance (up to 60%) homebuyers.

### BRIEF SUMMARY OF THE INVENTION

The invention is a method and system accessible with the Internet by which a database of homebuyers and their purchase criteria is established by real estate agents of the homebuyers, and is searchable by homeowners who are considering selling their homes.

The real estate marketing method of this invention generally entails storing desired home criteria of a plurality of potential homebuyers on a real estate marketing system through the Internet. Home information remotely entered by a potential homeseller through the Internet is then received on the system. The system is then searched to identify one or more matches between the home information of the potential homeseller with the desired home criteria of at least one of the plurality of potential homebuyers. In response to a match being identified between the home information of the homeseller and the desired home criteria of a homebuyer, the system sends the contact information of the potential homeseller to a real estate agent.

The real estate marketing system of this invention generally entails means for storing desired home criteria of a plurality of potential homebuyers on the system through the Internet, means for receiving home information that has been remotely entered by a potential homeseller on the system through the Internet, means for searching the storing means to identify one or more matches between the home information of the potential homeseller with the desired home criteria of at least one of the plurality of potential homebuyers, and means for sending contact information of the potential homeseller to a real estate agent in response to a match being identified between the home information and the desired home criteria.

In view of the above, it can be seen that a significant advantage of this invention is that a real estate agent contacted by the system/method of this invention has the opportunity to respond to potential homesellers and solicit them for listings. For this valuable opportunity, access to the system via the Internet can be obtained by agents through a subscription fee paid by the agents. The homebuyer's contact information can remain with the buyer agent, for example, by the agent entering into the database only the homebuyer's criteria, such as price range, location (zip code), home features, etc. The system and method of this invention are also useful tools of homeowners, in that in response to a match within a hit list generated from the homebuyer database, the homeowner has the option, though would not need to be required, to forward contact information to any one or more of the real estate agents working with the homebuyers in the hit list.

Other objects and advantages of this invention will be better appreciated from the following detailed description.

### BRIEF DESCRIPTION OF THE DRAWINGS

FIG. 1 is a flowchart representing preferred steps carried out in accordance with a real estate marketing system and method of this invention.

### DETAILED DESCRIPTION OF THE INVENTION

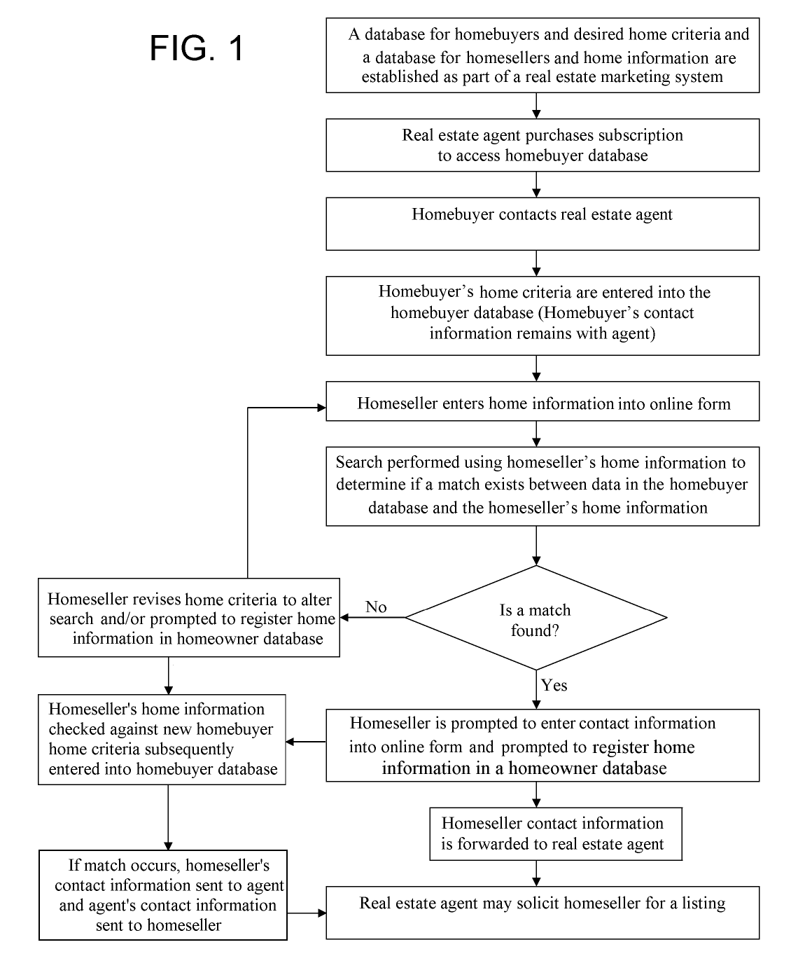

The invention is a method and system accessible with and through the Internet (or another computer networking system) by which a database of homebuyers and their home criteria can be established and searched. As will be evident from the following, the invention also provides real estate agents with opportunities to market homebuyers as a commodity to potential homesellers. As represented by the flowchart of FIG. 1, the method involves certain steps performed by the system. Components of the system capable of carrying out these steps are well known to those skilled in the art, and therefore will not be discussed in any detail here.

The system and method require the establishment of an electronic database in which the desired home criteria of any number of homebuyers can be stored. Potential criteria include those categories of housing information often employed with home listings, such as price range, location (e.g., by zip code), square footage, lot/property size, and various amenities including the existence of a garage and its size, number of bedrooms and bathrooms, etc. Such a homebuyer database can be stored on a computer connected to the Internet. Access to the homebuyer database via the Internet is then offered by subscription to real estate agents, such as by accessing a web site associated with the system and hosted by a computer, server, or other computing device associated with the system. When a homebuyer contacts a subscribing agent, the homebuyer's agent enters the desired home criteria of the homebuyer into the homebuyer database. For this purpose, an online fillable form can be provided on the system web site. Preferably, the homebuyer's identity and other potential contact information remain with the homebuyer's agent. For this purpose, the homebuyer's identity can be entered on the form and stored on the homebuyer database, but with access thereto restricted. Alternatively, the agent can separately associate the homebuyer's identify with a private code that is entered on the online form.

The system is further set up so that the homebuyer database is freely available and searchable over the Internet, and therefore to homeowners considering selling their homes as well as those who are merely curious. When accessing the system via the web site associated with the system, a homeowner (potential home seller) is prompted, such as with an online form, to enter information regarding their home. The prompted information includes at least one and preferably multiple categories of housing information that coincide with the categories employed in the homebuyers' desired home criteria. The homeowner is then allowed to perform a search through the homebuyer database to determine if any matches exist between the housing information entered by the homeowner and the criteria stored in the homebuyer database within any one or more of the coinciding categories. Matches preferably appear in a hit list, preferably in which the matching criteria are identified but without any indication of the homebuyer's identity. If a match is found, the homeowner is prompted to forward his or her contact information, such as an address, email address, telephone number, etc., for any one or more of the matches in the hit list. The homeowner can be prompted to enter his or her contact information, for example, with an online form, before or after the search. By forwarding their contact information for a given match, the homeowner's contact information is preferably automatically delivered to the homebuyer's agent via the Internet, such as by email. The notified agent then has the option of contacting the homeowner for a listing. Alternatively, the system may allow the homeowner to forego the contact information and leave the web site. In the event that a match is not obtained or an excessive number of matches are obtained, the homeowner is preferably allowed to revise and resubmit the housing information in order to alter (e.g., narrow or broaden) the search.

As evident from FIG. 1, the system can also be set up to prompt the homeowner to register or otherwise enter their home information in a separate homeowner database stored in the system. This prompt can occur whether or not a match resulted from the search performed by the homeowner. The prompted information may be limited to the home information originally entered by the homeowner for the search, or may include additional categories of home information, or may exclude certain categories used in the search. The system can then automatically perform one or more searches through the homebuyer database to determine if any subsequent matches occur as a result of desired home criteria of new homebuyers being entered into the homebuyer database. Such searches may be performed at regular intervals, though preferably at least each time a new homebuyer or a set number of new homebuyers are added to the homebuyer database. If a match is found during such a search, both the homeowner and the agent for the new homebuyer are preferably notified of the match. For example, the homeowner's contact information may be automatically forwarded to the homebuyer's agent, and the agent's contact information may be automatically forwarded to the h homeowner. As before, such contacts can be made via the Internet, such as by email, and the notified agent then has the option of contacting the homeowner for a listing.

To perform the above, it will be readily appreciated that the system requires one or more devices that can be accessed through the Internet and configured for storing the desired home criteria of homebuyers and hosting the web site. As noted above, any number of computers or servers connected to the Internet can serve this purpose. Homeowners will also access the web site through a computer, such that the homeowner's housing information and contact information can be remotely entered by the homeowner and received by the system through the Internet. The computer or server hosting the web page or any computers connected thereto can perform the searching operation. All such equipment are well within the capability of individuals with ordinary computer networking and web hosting skills, and therefore will not be described in any further detail.

From the above, it can be appreciated that the method and system can be set up so that each homebuyer in the homebuyer database is working with a real estate agent, and all contact information for an individual homebuyer stays with the homebuyer's agent. Only the homebuyer's criteria are shared through accessing the web site via the Internet. The system can accesses the desired home criteria of all homebuyers entered in the homebuyer database to generate matches. When the system detects a match between a homeowner and one or more homebuyers, at the homeowner's option the agent or agents working with the one or more homebuyers can be automatically contacted and given the homeowner's contact information. Advantageously, this step gives the agent the opportunity to contact the homeowner and list the homeowner's home for sale. The agent pays for this opportunity through the subscription to the system.

Also from the above, one can see that by marketing the homebuyer as a commodity to a homeowner, the method and system of this invention reverse the conventional process of soliciting for a listing. By sharing this information to the public and the real estate community, the sale of homes can take place more efficiently. This information can be used by the real estate community in many different ways. As a tool for marketing homebuyers to homeowners, an agent has the opportunity to market his or her homebuyers as they would market a home they have listed. As a listing tool to show homeowners, an agent can show a seller a large pool of homebuyers. By generating more opportunities to sell listings, matching homebuyers and homeowners will take place in a more efficient manner. With the invention, for-sale-by-owners (FSBO) are also provided with a convenient way to contact real estate agents. Subscribing agents have access to all homebuyers' criteria on the homebuyer database, enabling the agents to search a potentially very large database for homebuyer matches. The confidentiality and agency relationship between agents and homebuyers can be retained since the homebuyers' identifications can remain with their agents, while the identity of homebuyers within the homebuyer database can be limited to a convenient and confidential identifier, such as a private code. When an agent lists a home of a homeowner, the agent can contact all the agents who have buyers, and the agent can particularly target listings to homebuyer agents who have homebuyers that match a listing. The result is a lower average days on the market and more sales with less effort.

While the invention has been described in terms of a preferred embodiment, it is apparent that other forms could be adopted by one skilled in the art. Therefore, the scope of the invention is to be limited only by the following claims.

1. A real estate marketing system comprising:
means for storing desired home criteria of a plurality of potential homebuyers on the system through the Internet;
means for receiving home information that has been remotely entered by a potential homeseller on the system through the Internet;
means for searching the desired home criteria storing means to identify one or more matches between the home information of the potential homeseller with the desired home criteria of at least one of the plurality of potential homebuyers; and
means for sending contact information of the potential homeseller to a real estate agent in response to a match being identified between the home information and the desired home criteria.

2. A system according to claim 1, wherein the desired home criteria is contained in a homebuyer database and the desired home criteria storing means is a computer storage device.

3. A system according to claim 2, further comprising means for the real estate agent to purchase a subscription to the system so as to obtain access to the homebuyer database.

4. A system according to claim 1, further comprising means for prompting the potential homeseller to enter the contact information into the system in response to the match identified between the home information and the desired home criteria.

5. A system according to claim 1, further comprising means for the real estate agent to solicit a real estate listing from the potential homeseller who sent the contact information after the match was identified.

6. A system according to claim 5, further comprising means for identities of the plurality of potential homebuyers to remain confidential until a potential homeseller lists their home with the real estate agent.

7. A system according to claim 1, further comprising a website that is an element of each of the desired home criteria storing means, the desired home criteria searching means, the receiving means, and the sending means and through which the desired home criteria storing means, the desired home criteria searching means, the receiving means, and the sending means communicate and interact.

8. A system according to claim 1, further comprising:
means for storing the home information of the potential homeseller on the system through the Internet; and
means for prompting the potential homeseller to register the home information thereof in the home information storing means.

9. A system according to claim 8, further comprising:
means for searching the home information storing means to identify one or more matches between the home information of the potential homeseller with additional desired home criteria stored on the desired home criteria storing means; and
means for sending at least one of the contact information of the potential homeseller to a real estate agent and contact information of a real estate agent to the potential homeseller in response to a match being identified between the home information and the additional desired home criteria.

10. A system according to claim 9, wherein the home information searching means is operative to search the home information storing means each time an additional desired home criteria is stored on the desired home criteria storing means.

11. A real estate marketing method comprising:
storing desired home criteria of a plurality of potential homebuyers on a homebuyer database of a real estate marketing system through the Internet;
receiving home information that has been remotely entered by a potential homeseller on the system through the Internet;
searching the homebuyer database to identify one or more matches between the home information of the potential homeseller with the desired home criteria of at least one of the plurality of potential homebuyers; and
sending contact information of the potential homeseller to a real estate agent in response to a match being identified between the home information and the desired home criteria.

12. A method according to claim 11, further comprising marketing subscriptions for the real estate marketing system to a plurality of real estate agents so as to obtain access to the homebuyer database.

13. A method according to claim 12, wherein the plurality of potential homebuyers contact the plurality of real estate agents, and the plurality of real estate agents enter the desired home criteria of the plurality of potential homebuyers into the real estate marketing system.

14. A method according to claim 11, wherein the potential homeseller enters the contact information in response to the match being identified.

15. A method according to claim 14, further comprising the real estate agent contacting the potential homeseller in order to solicit a listing of the potential homeseller's home.

16. A method according to claim 15, further comprising confidentially maintaining the identities of the potential homebuyers identities until the potential homeseller lists the home with the real estate agent.

17. A method according to claim 11, further comprising prompting the potential homeseller to register the home information thereof in a home information database.

18. A method according to claim 17, further comprising:
searching the home information database to identify one or more matches between the home information of the potential homeseller with additional desired home criteria stored on the homebuyer database; and
sending at least one of the contact information of the potential homeseller to a real estate agent and contact information of a real estate agent to the potential homeseller in response to a match being identified between the home information and the additional desired home criteria.

19. A method according to claim 18, wherein the step of search the home information database is performed each time an additional desired home criteria is stored on the homebuyer database.
